(19) United States
(12) Patent Application Publication
(10) Pub. No.: US 2006/0054128 A1
(43) Pub. Date: Mar. 16, 2006

(54) Apparatus and method for detecting coolant belt slippage

(76) Inventors: Neil Allyn, Vancouver (CA); Aleks Velhner, Richmond (CA)

Correspondence Address: NORMAN M. CAMERON, SUITE 1401 - 1166 ALBERNI STREET, VANCOUVER, BC, V6E 3Z3, CA

(21) Appl. No.: 10/940,997

(22) Filed: Sep. 15, 2004

(51) Int. Cl. F02D 41/22; G01M 15/00

(52) U.S. Cl. 123/198 D; 73/118.1

(57) ABSTRACT

A method and apparatus for detecting slippage of a coolant pump drive belt on an internal combustion engine having a generator driven by the belt. The method comprises monitoring electrical output of the generator and determining that coolant belt slippage has occurred when the electrical output is reduced below a normal electrical output level.

### BACKGROUND OF THE INVENTION

This invention relates to auxiliary power units and, in particular, to apparatuses and methods for detecting slippage of coolant belts thereof.

This invention relates to auxiliary power units and, in particular, to apparatuses and methods for detecting slippage of coolant belts thereof.

Auxiliary power units are used for various purposes and may be installed, for example, on diesel-engined vehicles to maintain certain functions when the main engine is off. These units include a smaller internal combustion engine, usually diesel-fueled, and an alternator or some other type of electrical generator to power such things as the air-conditioning system.

Various safety and diagnostic systems are incorporated into such an auxiliary power unit to monitor its operation and, in some cases, to shut down the auxiliary power unit when certain contingencies arise. These auxiliary power units may include a coolant pump and an alternator or other type of generator, both conventionally being driven by a common drive belt, usually a V-belt. If the V-belt slips or breaks, the coolant pump no longer operates and the engine is subject to overheating and potential damage to the engine. As a result it is common to incorporate a safety device which shuts down the engine in the event that the belt breaks.

One way of detecting belt slippage or breakage in the prior art is to incorporate a temperature sensor in the coolant system of the engine. If the coolant pump stops, then, in theory, the temperature of the coolant increases. The temperature sensor senses this increase in temperature and shuts down operation of the engine. However, in actual fact, an air pocket often forms adjacent to the temperature sensor when the coolant pump stops and this air pocket prevents the temperature sensor from accurately measuring the temperature of the coolant. As a result, the belt potentially can slip or break and yet the engine will not be disabled because the temperature sensor does not sense the resulting temperature rise in the coolant.

U.S. Pat. No. 2,809,224 discloses an arrangement where electric current for the ignition system of an engine is supplied solely by the generator (and not the battery) after the engine has started. Fan belt breakage accordingly causes the engine to stop and prevents overheating. The voltage however is not actually monitored and apparently the engine would only stop if the belt actually breaks or slips a very significant amount. Thus it provides no early warning of the problem and results in abrupt shutting off of the engine.

U.S. Pat. No. 3,877,003 discloses a system for detecting fan belt slippage which may result in overheating. This is done by comparing the rotation of a member rotated by the fan belt with the rotation of the engine shaft. However the device is relatively complicated.

Various other patents do not specifically discuss cooling system alarms or monitoring as an objective, but deal with an analysis of power output from an alternator or generator to diagnose drive belt slippage. U.S. Pat. No. 6,029,512, for example, detects the speed of the alternator from the frequency of the ripple in the output voltage.

Japanese Patent JP 54160908 uses a counter to detect slip rate and provides a warning lamp to indicate an alarm to recognize slip of the belt.

Japanese Patent JP 60151445 uses a pulse signal and the ratio of alternator rotational speed to engine speed to detect slip. A charge lamp indicates abnormality.

### SUMMARY OF THE INVENTION

According to a first aspect of the invention, there is provided a method for detecting slippage of a coolant pump drive belt on an internal combustion engine having a generator driven by said belt. The method comprises monitoring electrical output of the generator and determining that coolant belt slippage has occurred when the electrical output is reduced below a normal electrical output level.

According to a second aspect of the invention, there is provided an auxiliary power unit having an internal combustion engine with a coolant pump, a generator and a drive belt operatively engaging the coolant pump and the generator. A coolant belt slip detector comprises an electrical output monitor coupled to the generator, reduced electrical output indicating coolant belt slippage.

According to a third aspect of the invention, there is provided a power unit having an internal combustion engine with means for disabling the engine. There is an alternator, the alternator including means for providing a first signal when the alternator output is below a specified level. A drive belt operatively connects the alternator to the engine. A controller is connected to the alternator for receiving the first signal and providing a second signal to the means for disabling the engine, whereby the engine is disabled when the alternator output is below the specified level.

According to a fourth aspect of the invention, there is provided a method of disabling an engine having an alternator operatively coupled to the engine by a drive belt, when slippage of the drive belt or breakage of the drive belt occurs. The method comprises providing a first signal from the alternator to a controller when output of the alternator is below a specified level and providing a second signal from the controller to a means for disabling the engine when the controller receives the first signal from the alternator, thereby disabling the engine.

The invention offers significant advantages compared to prior art. Early detection of belt slippage is possible by monitoring the output of the alternator and thus the engine of the auxiliary power unit can be stopped before damage has occurred due to overheating. In addition, the method and apparatus require the addition of few components to a conventional auxiliary power unit, thus resulting in a relatively inexpensive safety feature. Moreover, compared to prior art systems using coolant temperature sensors, air or gas pockets in the coolant system do not adversely affect operation of the invention.

### BRIEF DESCRIPTION OF THE DRAWING

Referring to the drawing:

FIG. 1 is a simplified, partly diagrammatic view of an auxiliary power unit incorporating a coolant belt slippage detection system according to an embodiment of the invention.

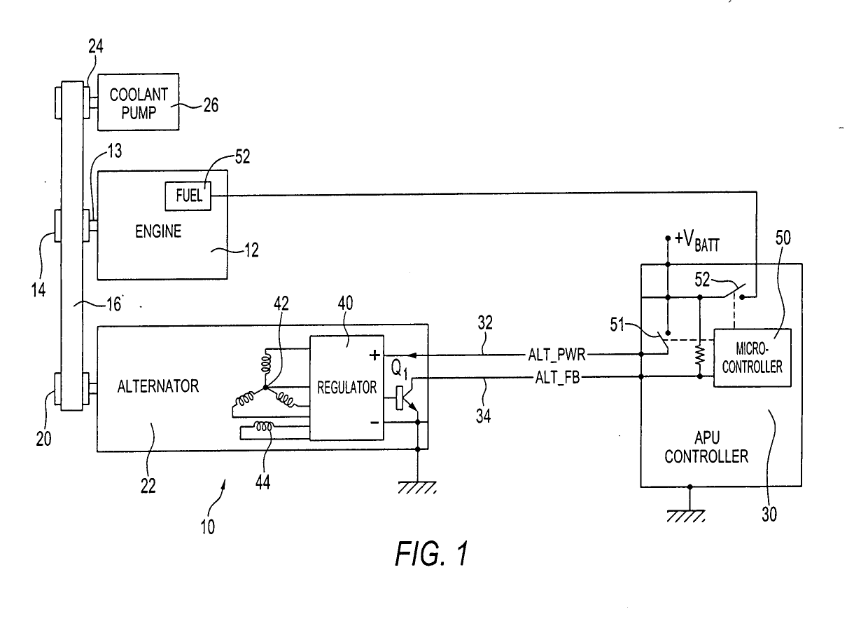

### DETAILED DESCRIPTION OF THE PREFERRED EMBODIMENT

Referring to the drawing, this shows an auxiliary power unit 10 which is generally conventional and includes an internal combustion engine 12, a diesel engine in this particular example. The engine has a sheave 14 mounted on the crankshaft 13 of the engine in the conventional manner. A continuous drive belt 16, a V-belt in this example, extends about the sheave 14 as well as sheave 20 on alternator 22 and sheave 24 on coolant pump 26. These components are conventional and thus are not described in more detail.

There is an APU controller 30 connected to the output of the alternator 22 by conductors 32 and 34. The alternator is a conventional type and includes a regulator 40, a three-phase armature winding 42 and a field winding 44. There is an NPN transistor Q₁ with a base connected to the regulator, an emitter connected to ground and a collector connected to the conductor 34. Alternatively, in other embodiments of the invention, Q₁ can be a PNP transistor, an n-channel MOSFET or a p-channel MOSFET transistor. The transistor operates as a switch and, in conventional installations, turns on a “check engine” light on the dashboard of a vehicle to indicate that alternator output is below a specified level and the battery is not being charged. This could indicate that the alternator is not functioning properly or that the belt 16 has broken. However the light also typically comes on when the engine is starting. Thus conventionally the power supplied to the light would not indicate necessarily that the belt has broken or slipped and could not be used to disable the engine since this could prevent the engine from starting. The invention utilizes the signal provided by transistor Q₁ to indicate that the belt has broken or is slipping, but ignores the signal when the engine is starting since that would not indicate a problem with the belt.

Specifically, microcontroller 50 of the APU controller provides signals to operate two switches S₁ and S₂. In normal operation switch S₂ is closed and battery voltage V_{BATT} is supplied to fuel solenoid 52 of engine 12 so the engine is supplied with fuel. At the same time, switch S₁ is closed and the alternator supplies current for the battery. Alternator feedback ALT_FB provides a high signal via conductor 34 during normal operation.

If the belt 16 breaks or slips, the base of transistor Q₁ receives power from the regulator 40 and turns on, changing ALT_FB to a low state which is sensed by the microcontroller 50 which opens switch S₂, thereby shutting off power to the fuel solenoid 52, thereby shutting off fuel to the engine and causing the engine to shut down. It should be understood that the invention is applicable to other means for shutting down the engine such as an ignition cut off.

During the engine starting sequence, the microcontroller 50 first closes switch S₁, providing power to the regulator 40 which provides power to the base of transistor Q₁ because the regulator does not receive power from the alternator windings. Transistor Q₁ turns on, changing ALT FB to a low state. However, the microcontroller 50, sensing that this is the starting sequence, ignores the ALT_FB signal.

When the engine starts, the alternator starts producing power, the transistor Q₁ turns off and ALT_FB goes to a high state. This indicates to microcontroller 50 that the engine has started successfully. Thereafter, if Q₁ turns on and, ALT_FB goes low, the engine shuts down if ALT_FB stays low for a predetermined period of time, five seconds in this example. That is taken as an indication that the belt 16 has broken, the belt slipping or that the alternator is faulty. In any of these cases the engine 12 is shut down by cutting off the fuel supply via solenoid 52.

It will be understood by someone skilled in the art that many of the details provided above are by way of example only and are not intended to limit the scope of the invention which is to be determined with reference to the following claims.

What is claimed is:

1. A method for detecting slippage of a coolant pump drive belt on an internal combustion engine having a generator driven by said belt, the method comprising monitoring electrical output of the generator and determining that coolant belt slippage has occurred when the electrical output is reduced below a normal electrical output level.

2. The method as claimed in claim 1, wherein the electrical output is output voltage of the generator.

3. The method as claimed in claim 2, wherein the generator is an alternator.

4. The method as claimed in claim 3, wherein the internal combustion engine is located in an auxiliary power unit.

5. An auxiliary power unit having an internal combustion engine with a coolant pump, a generator, a drive belt operatively engaging the coolant pump and the generator, and a coolant belt slip detector comprising an electrical output monitor coupled to the generator, reduced electrical output indicating coolant belt slippage.

6. The power unit as claimed in claim 5, wherein the electrical output monitor is a voltage sensor.

7. The power unit as claimed in claim 5, wherein the generator and the coolant pump have sheaves, the drive belt extending about said sheaves.

8. The power unit as claimed in claim 5, wherein the generator is an alternator.

9. A power unit, comprising:
an internal combustion engine including means for disabling the engine;
an alternator, the alternator including means for providing a first signal when the alternator output is below a specified level;
a drive belt operatively connecting the alternator to the engine; and
a controller connected to the alternator for receiving the first signal and providing a second signal to the means for disabling the engine, whereby the engine is disabled when the alternator output is below the specified level.

10. The power unit as claimed in claim 9, wherein the controller provides the second signal only after the engine has started.

11. The power unit as claimed in claim 10, wherein the means for providing the first signal includes a switch.

12. The power unit as claimed in claim 11, wherein the switch includes a transistor.

13. The power unit as claimed in claim 12, wherein the transistor is an n-p-n transistor having a base and the means for providing the first signal further comprises a regulator for the alternator, the regulator providing a third signal to the base of the transistor when the output of the alternator is below the specified level.

14. The power unit as claimed in claim 9, wherein the controller provides the second signal only after the engine has started and the controller receives the first signal for a specified period of time.

15. The power unit as claimed in claim 9, wherein the means for disabling the engine includes a fuel shut off device.

16. A method of disabling an engine, having an alternator operatively coupled to the engine by drive belt, of when slippage of the drive belt or breakage of the drive belt occurs, the method comprising providing a first signal from the alternator to a controller when output of the alternator is below a specified level and providing a second signal from the controller to a means for disabling the engine when the controller receives the first signal from the alternator, thereby disabling the engine.

17. The method as claimed in claim 16, wherein the controller provides the second signal only after the engine has started.

18. The method as claimed in claim 17, wherein the means for providing the first signal includes a switch.

19. The method as claimed in claim 18, wherein the switch includes a transistor.

20. The method as claimed in claim 19, wherein the transistor is an NPN transistor having a base and the means for providing the first signal further comprises a regulator for the alternator, the regulator providing a third signal to the base of the transistor when the output of the alternator is below the specified level.

21. The method as claimed in claim 16, wherein the controller provides the second signal only after the engine has started and the controller receives the first signal for a specified period of time.
